(19) United States
(12) Patent Application Publication
(10) Pub. No.: US 2003/0051159 A1
(43) Pub. Date: Mar. 13, 2003

(54) Secure media transmission with incremental decryption

(76) Inventors: Steven H. McCown, Brighton, CO (US); Stephen S. Selkirk, Broomfield, CO (US); Thomas Nelson Noland, Louisville, CO (US); Michael L. Leonhardt, Longmont, CO (US); Charles A. Milligan, Golden, CO (US)

Correspondence Address: DUKE W. YEE, CARSTENS YEE & CAHOON, LLP, P.O. BOX 802334, DALLAS,, TX, 75380, US

(21) Appl. No.: 09/951,688

(22) Filed: Sep. 11, 2001

(51) Int. Cl. H04L 9/32

(52) U.S. Cl. 713/201

(57) ABSTRACT

A method, computer program product, and data storage device for downloading data with variable quality (including audio or video data) from a server in a network to a computer or network-connected storage device is disclosed.

A file is encrypted using multiple keys, such that possessing less than all of the keys allows only a portion of the data to be decrypted. The quality of level of the data read decrypted from the file is dependent upon which keys the downloading party holds. The file is downloaded to a computer or network-connected storage device.

### BACKGROUND OF THE INVENTION

1. Technical Field

The present invention is directed toward the downloading of data from a network. More specifically, the present invention is directed toward a storage device, data processing system, method, and computer program product for downloading encrypted data with variable quality.

2. Description of Related Art

Internet, also referred to as an “internetwork”, in communications is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. Operating costs may be reduced by providing informational guides and/or searchable databases of public records online.

Currently, the most commonly employed method of transferring data over the Internet is to employ the World Wide Web environment, also called simply “the web”. Other Internet resources exist for transferring information, such as File Transfer Protocol (FTP) and Gopher, but have not achieved the popularity of the web. In the web environment, servers and clients effect data transaction using the Hypertext Transfer Protocol (HTTP), a known protocol for handling the transfer of various data files (e.g., text, still graphic images, audio, motion video, etc.). Information is formatted for presentation to a user by a standard page description language, the Hypertext Markup Language (HTML). In addition to basic presentation formatting, HTML allows developers to specify “links” to other web resources identified by a Uniform Resource Locator (URL). A URL is a special syntax identifier defining a communications path to specific information. Each logical block of information accessible to a client, called a “page” or a “web page”, is identified by a URL. The URL provides a universal, consistent method for finding and accessing this information by the web “browser”. A browser is a program capable of submitting a request for information identified by a URL at the client machine. Retrieval of information on the web is generally accomplished with an HTML-compatible browser, such as, for example, Netscape Communicator, which is available from Netscape Communications Corporation.

When a user desires to retrieve a document, such as a web page, a request is submitted to a server connected to a client computer at which the user is located and may be handled by a series of servers to effect retrieval of the requested information. The selection of a document is typically performed by the user's selecting a hypertext link. The hypertext link is typically displayed by the browser on a client as a highlighted word or phrase within the document being viewed with the browser. The browser then issues a hypertext transfer protocol (HTTP) request for the requested documents to the server identified by the requested document's URL. The server then returns the requested document to the client browser using the HTTP. The information in the document is provided to the client formatted according to HTML. Typically, browsers on personal computers (PCs) along with workstations are typically used to access the Internet. The standard HTML syntax of Web pages and the standard communication protocol (HTTP) supported by the World Wide Web guarantee that any browser can communicate with any web server.

Among the types of data that may be retrieved from the Internet are audio, music, or video files such as MP3 files, WAV files, AIFF files, MPEG files, RealVideo, and the like. These files typically contain data that may be expressed with varying quality levels. For instance, graphic resolution, sampling rate, and data compression quality are all factors that may be varied with respect to a particular file.

The sampling rate of sampled data is one example of a quality level that may be varied in various types of files. Sampled data, for the purposes of this application, is data that is recorded at periodic intervals (called samples). In the case of video data, the periodic states are frames of video. For audio data, the periodic states are amplitude levels in an audio signal. One of ordinary skill in the art will appreciate that many types of data fit this definition of sampled data, including non-audiovisual data, such as survey results, temperature measurements, or other data that is recorded at periodic intervals.

The sampling rate of sampled data is the number of samples taken per unit of time. Accordingly to sampling theory, the greater the sampling rate, the greater the fidelity, when the sampled data is used to reconstruct the original signal. In the case of audio and video, this translates into smoother movement, better picture quality, and improved sound quality.

From a business perspective, it would make sense to charge customers a higher rate to purchase information that is of higher quality, since such information would logically be of higher intrinsic value to a customer. Marketing a product with several levels of quality is an established and effective business practice. Another effective marketing technique with respect to products sold with varying levels of quality is to provide upgrades to customers' existing products to raise them to a higher level of quality or performance.

Also, data files of all kinds are readily exchanged between users. This phenomenon has been a driving force behind the success of web sites such as “Napster,” which facilitates the exchange of audio files between users. Such ready ability to exchange audio files, however, has also made piracy of copyrighted audio material easier. “Napster,” for example, has been the subject of recent, highly-publicized copyright infringement litigation.

What makes downloadable files so readily pirated is the fact that whenever a file is downloaded, a copy of the file is made on the downloading computer. In a perfect scenario (from the copyright owner's perspective), a user who legitimately downloads an audio file from an authorized site will transfer the content from the file onto a compact disc, Digital Versatile Disc (DVD), or other suitable tangible format, then delete the downloaded file. The presence of the file on the computer's hard drive, however, makes it easy and tempting to illegally exchange the file with others.

Pending U.S. patent application Ser. No. ______, attorney docket 2001-025-SFT, entitled “Anti-Piracy Network Storage Device,” which is incorporated herein by reference, addresses the pirating concern by disclosing the downloading of encrypted data directly to a network-attached storage device, where the storage device performs the decryption internally, so that no additional copies (say, on a computer hard drive) are made. It would be desirable, then, to provide customers who purchase and download data, such as audio and video, a method of purchasing the data at varying levels of quality, then possibly upgrading the customer's purchased data at a later time to a higher quality. It would also be desirable to afford some protection from pirating of the data.

### SUMMARY OF THE INVENTION

Accordingly, the present invention is directed towards a method, computer program product, and data storage device for downloading data with variable quality (including audio or video data) from a server in a network to a computer or network-connected storage device.

A data file is encrypted using multiple keys, such that possessing less than all of the keys allows only a portion of the data to be decrypted. The quality level of the data read decrypted from the file is dependent upon which keys the downloading party holds. The file is downloaded to a computer or network-connected storage device.

Encryption serves multiple functions in that it prevents third-parties from intercepting and reading data transmissions, prevents downloading parties from accessing higher-quality media than they have access to, and can prevent downloading parties from making unauthorized copies by downloading the information directly to a storage device, thus bypassing a downloading party's computer system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which the processes of the present invention may be implemented;

FIG. 2A is a block diagram of a computer in which processes of the present invention may be implemented;

FIG. 2B is a block diagram of a network storage device in which processes of the present invention may be implemented;

FIG. 3 is a functional block diagram providing an overall view of a process of decryption in a preferred embodiment of the present invention;

FIG. 4 is a diagram depicting two types of sampled data in accordance with a preferred embodiment of the present invention;

FIG. 5 is a diagram depicting an encrypted sampled data file and decrypted portions of that file in accordance with a preferred embodiment of the present invention;

FIG. 6 is a diagram of a data structure for storing a key in accordance with a preferred embodiment of the present invention;

FIG. 7 is a diagram depicting the operation of an embodiment of the present invention using resolution as a quality level;

FIG. 8 is a flowchart representation of a process of transmitting an encrypted sampled data file in accordance with a preferred embodiment of the present invention; and

FIG. 9 is a flowchart representation of a process of receiving and decrypting a sampled data file in accordance with a preferred embodiment of the present invention.

### DETAILED DESCRIPTION OF THE PREFERRED EMBODIMENT

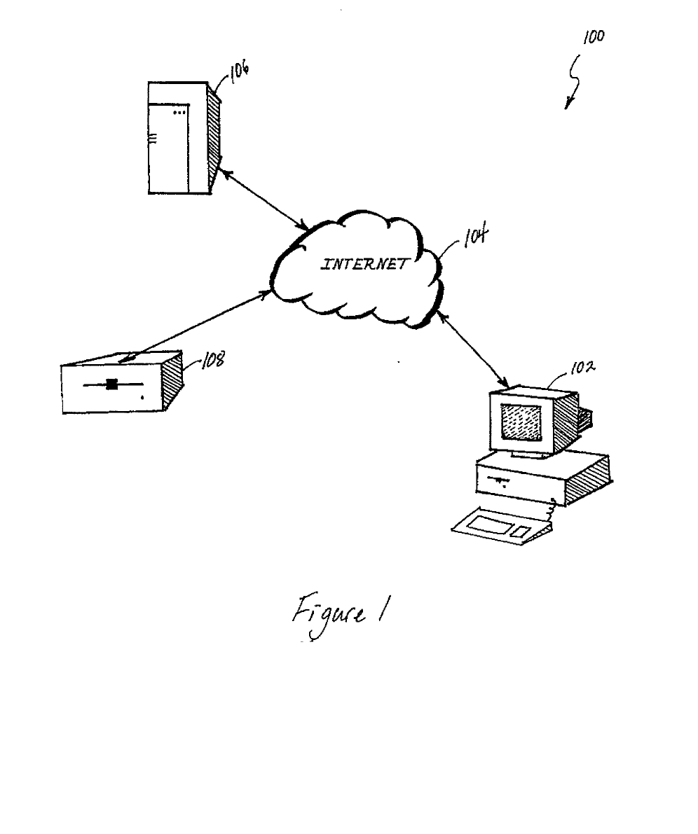

FIG. 1 depicts a distributed data processing system 100 in which the processes of the present invention may be implemented. Computer 102 connects to Internet 104, through which computer 102 communicates with server 106 and network storage device 108. In an embodiment of the present invention, computer 102 requests from server 106 that a particular item of data with a variable quality level, such as an audio file, be downloaded from server 106 to network storage device 108. In fulfillment of the request, server 106 contacts network storage device 108 directly and sends the data, in encrypted form, to network storage device 108. Transmitting the encrypted data directly to network storage device 108 ensures that no unencrypted copy is ever stored on computer 102, where it can be easily copied and perhaps “pirated.” In an alternative embodiment, a computer such as computer 102 may download the encrypted data.

The downloading device has access to one or more keys associated with the downloaded encrypted data. These keys may have been downloaded from server 106 or another server, such as a server supporting a retail website, for instance. In a preferred embodiment, such downloading of keys will be done over an encrypted channel using, for instance, the Secure Sockets Layer (SSL) or other similar protocol. The keys may also be provided on a tangible medium, such as a compact disc, smart card, bar code, or other computer-readable medium.

Various examples of data files with variable levels of quality exist. Sampled data files may have different sampling rates, but convey the same basic information. Sampled data, for the purposes of this application, is data that is recorded at periodic intervals (called samples). In the case of video data, the periodic states are frames of video. For audio data, the periodic states are amplitude levels in an audio signal. One of ordinary skill in the art will appreciate that many types of data fit this definition of sampled data, including non-audiovisual data, such as survey results, temperature measurements, or any other data that is recorded at periodic intervals. The present invention is intended to be applicable to all types of sampled data, according to this definition.

Other types of files may have other types of quality levels associated with them. For instance, video or graphics files may have variable resolution. Compressed files may be compressed with various levels of tolerable data loss. The present invention allows a single file to be downloaded that allows for varying quality levels, where the downloading party may read the downloaded file at a particular quality level by decrypting the file with cryptographic key(s) associated with a particular level of quality.

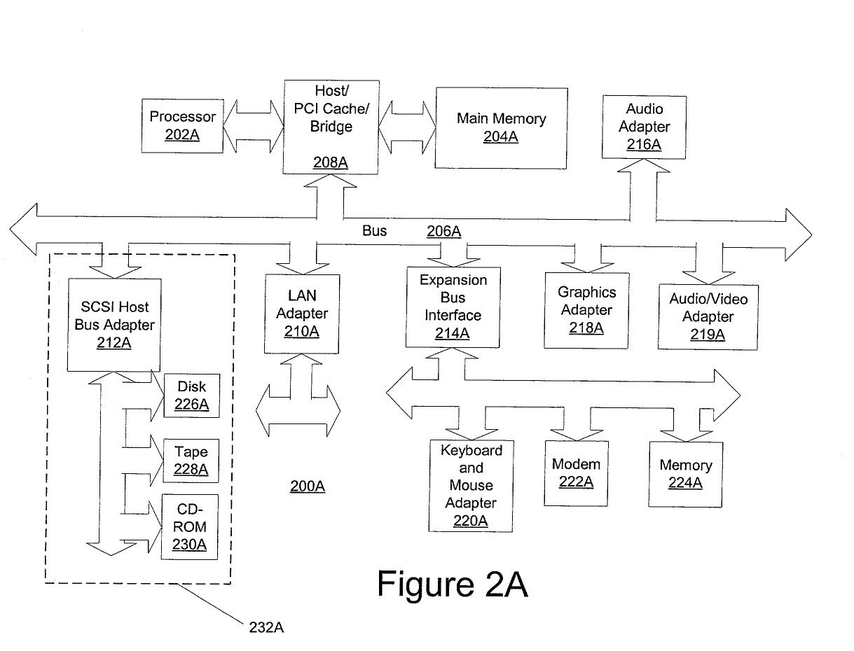

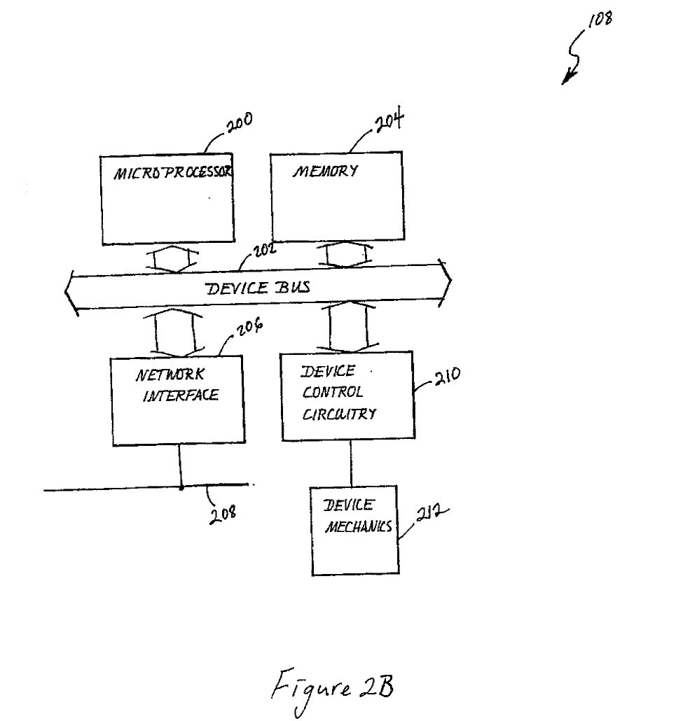

With reference now to FIG. 2A, a block diagram of a data processing system is shown in which a portion of the present invention may be implemented. Data processing system 200A is an example of a computer in which code or instructions implementing processes of the present invention may be located (e.g., computer 102 or server 106 from FIG. 1). Data processing system 200A employs a peripheral component interconnect (PCI) local bus architecture. Although the depicted example employs a PCI bus, other bus architectures such as Accelerated Graphics Port (AGP) and Industry Standard Architecture (ISA) may be used. Processor 202A and main memory 204A are connected to PCI local bus 206A through PCI bridge 208A. PCI bridge 208A also may include an integrated memory controller and cache memory for processor 202A. Additional connections to PCI local bus 206A may be made through direct component interconnection or through add-in boards. In the depicted example, local area network (LAN) adapter 210A, small computer system interface SCSI host bus adapter 212A, and expansion bus interface 214A are connected to PCI local bus 206A by direct component connection. In contrast, audio adapter 216A, graphics adapter 218A, and audio/video adapter 219A are connected to PCI local bus 206A by add-in boards inserted into expansion slots. Expansion bus interface 214A provides a connection for a keyboard and mouse adapter 220A, modem 222A, and additional memory 224A. SCSI host bus adapter 212A provides a connection for hard disk drive 226A, tape drive 228A, and CD-ROM drive 230A. Typical PCI local bus implementations will support three or four PCI expansion slots or add-in connectors.

An operating system runs on processor 202A and is used to coordinate and provide control of various components within data processing system 200A in FIG. 2A. The operating system may be a commercially available operating system such as Windows 2000, which is available from Microsoft Corporation. An object oriented programming system such as Java may run in conjunction with the operating system and provides calls to the operating system from Java programs or applications executing on data processing system 200A. “Java” is a trademark of Sun Microsystems, Inc. Instructions for the operating system, the object-oriented programming system, and applications or programs are located on storage devices, such as hard disk drive 226A, and may be loaded into main memory 204A for execution by processor 202A.

Those of ordinary skill in the art will appreciate that the hardware in FIG. 2A may vary depending on the implementation. Other internal hardware or peripheral devices, such as flash ROM (or equivalent nonvolatile memory) or optical disk drives and the like, may be used in addition to or in place of the hardware depicted in FIG. 2A. Also, the processes of the present invention may be applied to a multiprocessor data processing system.

For example, data processing system 200A, if optionally configured as a network computer, may not include SCSI host bus adapter 212A, hard disk drive 226A, tape drive 228A, and CD-ROM 230A, as noted by dotted line 232A in FIG. 2A denoting optional inclusion. In that case, the computer, to be properly called a client computer, must include some type of network communication interface, such as LAN adapter 210A, modem 222A, or the like. As another example, data processing system 200A may be a stand-alone system configured to be bootable without relying on some type of network communication interface, whether or not data processing system 200A comprises some type of network communication interface. As a further example, data processing system 200A may be a personal digital assistant (PDA), which is configured with ROM and/or flash ROM to provide non-volatile memory for storing operating system files and/or user-generated data.

The depicted example in FIG. 2A and above-described examples are not meant to imply architectural limitations. For example, data processing system 200A also may be a notebook computer or hand held computer in addition to taking the form of a PDA. Data processing system 200A also may be a kiosk or a Web appliance. The processes of the present invention are performed by processor 202A using computer implemented instructions, which may be located in a memory such as, for example, main memory 204A, memory 224A, or in one or more peripheral devices 226A-230A.

FIG. 2B is a block diagram depicting the structure of network storage device 108. A microprocessor 200B is embedded into network storage device 108 and functions as the control center for network storage device 108. Microprocessor 200B communicates through device bus 202B with memory 204B, from which it loads instructions for it to execute. Also connected to device bus 202B is a network interface 206B, which allows microprocessor 200B to send and receive data through network connection 208B, which in a preferred embodiment is connected to the Internet.

Device control circuitry 210B is connected to device bus 202B and provides an interface between microprocessor 200B and the physical storage components 212B of network storage device 108. Physical storage components 212B may store data to any of a variety of available tangible data storage media, including but not limited to, compact disc, digital versatile disc (DVD), magnetic disk, magnetic tape, optical disk, optical tape, and solid-state storage media (such as integrated circuit memory, including but not limited to static random access memory (SRAM), dynamic random access memory (DRAM), non-volatile random access memory (NVRAM), and flash memory).

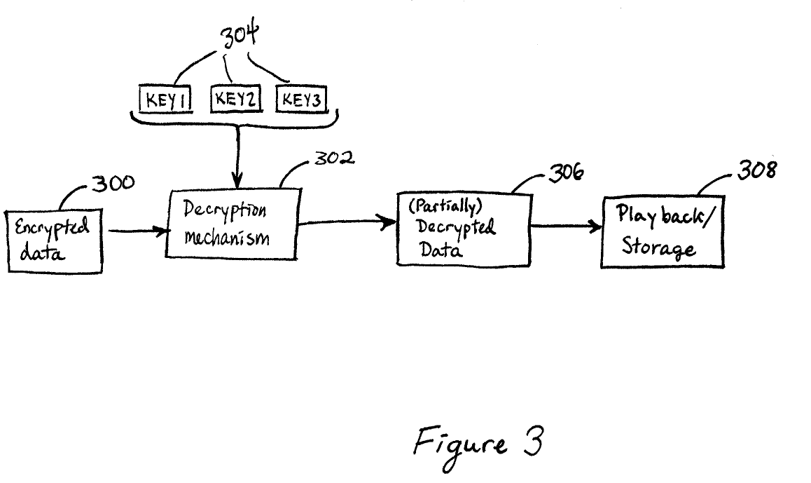

FIG. 3 is a functional block diagram providing an overall view of a process of decryption in a preferred embodiment of the present invention. Encrypted data 300 and a set of keys 304 are provided to a software decryption mechanism 302. Encrypted data 300 contains data recorded with various quality levels. Decryption mechanism 302 decrypts as much of encrypted data 300 as is possible using keys 304. What data is decrypted from encrypted data 300 is assembled into a new data file 306. At this point, any necessary adjustments may be made to new data file 306. For instance, in the case of sampled data, if not all of the data in encrypted data 300 was decrypted, the sampling rate for data file 306 is lowered to match the reduced number of samples. Finally, data file 306 may be played back (if, for example, an audio or video file), stored, or otherwise processed as appropriate (308).

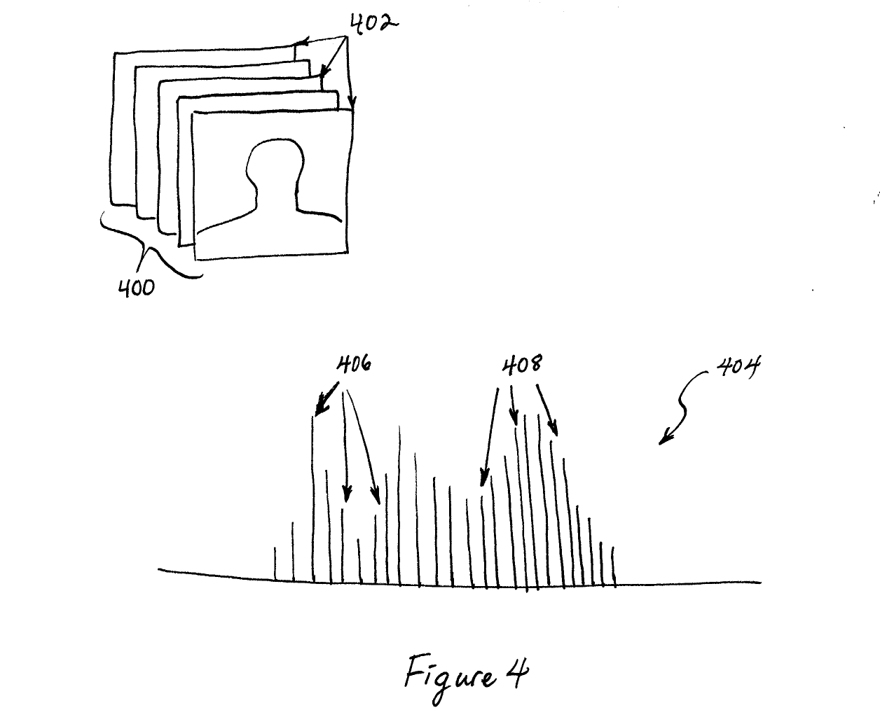

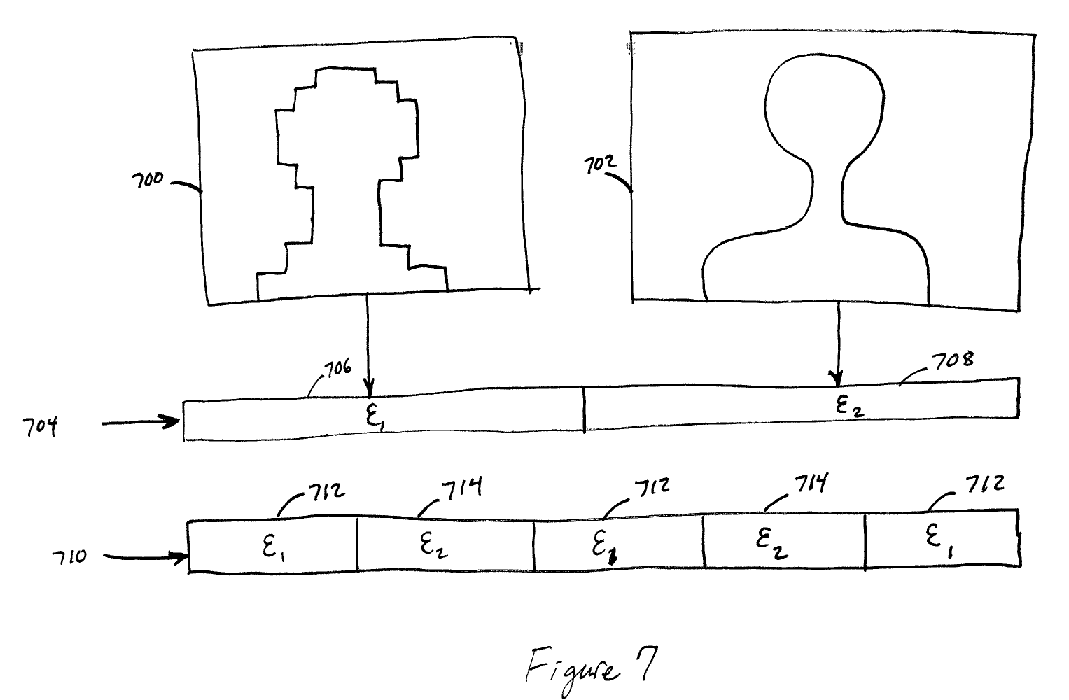

FIGS. 4-6 describe a preferred embodiment of the present invention in which a sampling rate is used as a measure of quality. It is to be understood that the processes of the present invention are applicable in situations in which data other than sampled data is used. FIG. 7 describes one such embodiment.

FIG. 4 is a diagram depicting two types of sampled data in accordance with a preferred embodiment of the present invention. These sampled data types are not intended be exhaustive, but were chosen merely to illustrate how sampled data can be partially reproduced, yet produce the desired perceived effect, albeit at a lowered level of quality. Video data is generally transmitted as a series of frames, which are still images representing the appearance of a display screen at discrete instances in time. Frames 400, for instance, represent a video transmission. The video transmission is played back by displaying frames 400 sequentially in rapid succession. If selected frames 402, evenly distributed across frames 400 are displayed sequentially in rapid succession (although at a lower rate), a video animation containing the same objects and motion will be displayed, but the quality of the display, and in particular the smoothness of motion, will be reduced.

Similarly, digital audio signal 404 comprises a number of discrete amplitude measurements taken over time, here represented by a graph. When these amplitudes are reproduced in a loudspeaker as voltages across the speaker element in rapid succession, a listener will perceive recorded sound.

Reproducing an evenly distributed fraction of those amplitude measurements at an appropriately lowered rate (i.e., reproducing every other amplitude measurement (406) or every third amplitude measurement (408)) will also be perceived as reproducing the same sound, but with degradation in quality. In particular, certain frequencies of sound will not be faithfully reproduced. This often results in a “tinny” sound, similar to what one hears in the earpiece of a telephone (since telephone equipment actually filters out many audible frequencies).

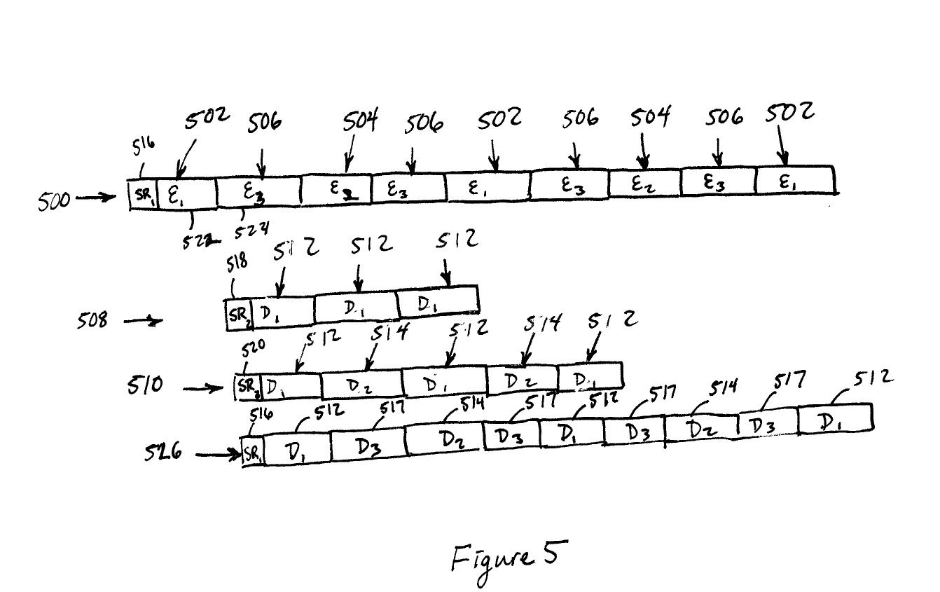

FIG. 5 is a diagram depicting an encrypted sampled data file and decrypted portions of that file in accordance with a preferred embodiment of the present invention. File 500 is an example of an encrypted sampled data file in accordance with a preferred embodiment of the present invention. File 500 contains a sample rate 516, which is the maximum sample rate for reproducing the data within file 500. This sample rate corresponds to the rate at which the decrypted data would be reproduced (e.g., played back) if the entirety of file 500 were decrypted. File 500 also contains encrypted portions 502, 504, 506. Portions 502, 504, and 506 are divided into segments (such as segment 522 and segment 524), which are evenly distributed across file 500. Each segment represents one or more data samples. Each of portions 502, 504, and 506 is encrypted using a separate cryptographic key. A wide variety of cryptographic algorithms could be used for this purpose, including the Data Encryption Standard (DES), described in U.S. Pat. No. 3,962,539, Shamir secret sharing, among others. The notations E₁, E₂, E₃ in the segments shown in FIG. 5 represent which key was used to encrypt the segment, “key 1,” “key 2,” or “key 3.” So as not to confuse, each “E₁” segment may contain different encrypted data, but all “E₁” segments were encrypted with key 1

The recipient of file 500 will be able to decrypt those portions of file 500 for which he or she possess the appropriate key. For example, if the recipient possess only the key used to encrypt portion 502 (“key 1”), the recipient will be able to decrypt only portion 502. The decrypted versions of the segments making up portion 502 can then be assembled to form file 508, which contains decrypted portion 512, corresponding to portion 502. As the number of samples in file 508 is reduced, as compared to file 500, a new sample rate 518, which is lower than the original maximum sample rate (516), is provided in file 508.

Similarly, if the recipient possesses the keys for portions 502 and 504 (keys 1 and 2), the recipient will be able to obtain file 510 through decrypting file 500. File 510 will have a sample rate 520 that is in between that of file 500 and file 508, and will include decrypted portion 514 corresponding to portion 504, in addition to decrypted portion 512. If the recipient possesses all of the keys (in this example, there were only three, but in practice, there could be any number of keys), then the recipient will be able to obtain file 526, which has the same sample rate (516) as file 500, and include decrypted portions 512, 514, and 517, corresponding to portions 502, 504, and 506, respectively; in other words, the recipient will be able to recover the full-quality version of the data. Thus, the recipient may upgrade the quality of the reproduced data by acquiring additional keys.

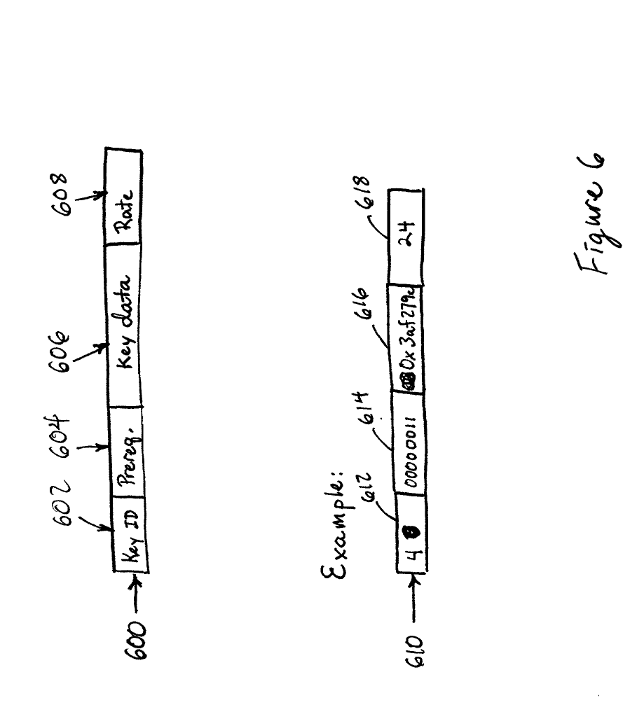

FIG. 6 is a diagram of a data structure for storing a key in accordance with a preferred embodiment of the present invention. The keys used within the present invention will preferably contain a raw cryptographic key as well as other information to facilitate the combining of keys with other keys. Data structure 600 is one possible format for a distributable key. Data structure 600 contains an identification code 602, which identifies which key it is, a list of prerequisite keys 604 (q.v.), the raw cryptographic key itself 606, and a sample rate 608.

As was shown in FIG. 5, one method of improving the quality of the reproduced sampled data in accordance with an embodiment of the present invention is to decrypt multiple portions of the encrypted file and combine the decrypted portions. It is important, therefore, for the software performing the decryption to know which portions should be combined with other portions to achieve the desired sampling rate. Using data structure 600, if the recipient of a file has several keys, the optimal data rate can be achieved by selecting the key with the highest sampling rate 608, then combining the portion corresponding to that key with those corresponding to prerequisite keys 604. Prerequisite keys 604 may be represented by a bit mask, such as that in example data structure 610. Example data structure 610 (representing key “4,” as identified by identification code 612), must be combined with keys 1 and 2 (represented by the 1's in bitmask 614) to yield a sampling rate of 24, as shown in sampling rate 618.

FIG. 7 is a diagram depicting the operation of an embodiment of the present invention in which the quality level is graphics resolution. Graphic 700 is a low-resolution computer graphic of a profile. Graphic 702 is a higher-resolution version of the same picture. In accordance with a preferred embodiment of the present invention, an encrypted file containing both versions of the picture encrypted with different keys, such as encrypted file 704 or encrypted file 710, may be created. Encrypted file 704 consists of two contiguous portions, portion 706 and portion 708. Portion 706 is a copy of graphic 700 that has been encrypted with a first key. Portion 708 is a copy of graphic 702 that has been encrypted with a second key. A user possessing the first key may decrypt and view the lower resolution graphic 700, and a user possessing the second key may decrypt and view the higher resolution graphic 702.

Encrypted file 710 also contains portions (712 and 714) representing the two graphics, but in this case, the two portions are broken into alternating segments, so as to be evenly-distributed across encrypted file 710. This alternating-segment approach is useful for data that is to be read as it is downloaded, since all of portion 712 need not be loaded before section 714 can be decrypted, for instance.

Thus, in general, multiple versions of a file with different quality levels may be encrypted with separate keys and combined into a single file, in accordance with a preferred embodiment of the present invention. As in the case with sampled data, different encrypted portions may be combined to achieve the desired level of quality, or as in the case with graphics of varying resolution, different complete versions of the data may be separately decrypted and displayed. One of ordinary skill in the art will recognize that these general principles may be applied to any types of information that may be expressed with varying levels of quality. The present invention is not limited in scope to the examples noted herein.

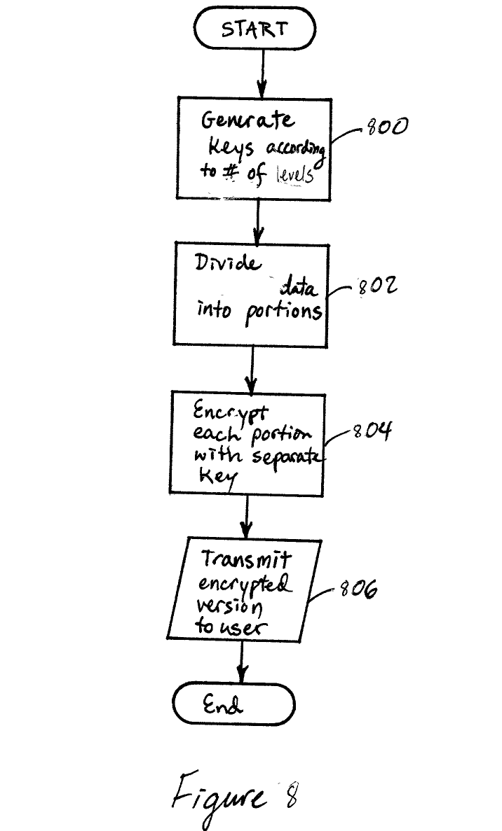

FIG. 8 is a flowchart representation of a process of transmitting an encrypted data file in accordance with a preferred embodiment of the present invention. First, a set of (possibly random) keys are generated according to the number of desired quality levels (step 800). Then, the data is divided into portions (step 802). Each portion is encrypted with a separate key taken from those generated (step 804). Finally, an encrypted version of the data is transmitted to a user/recipient (step 806).

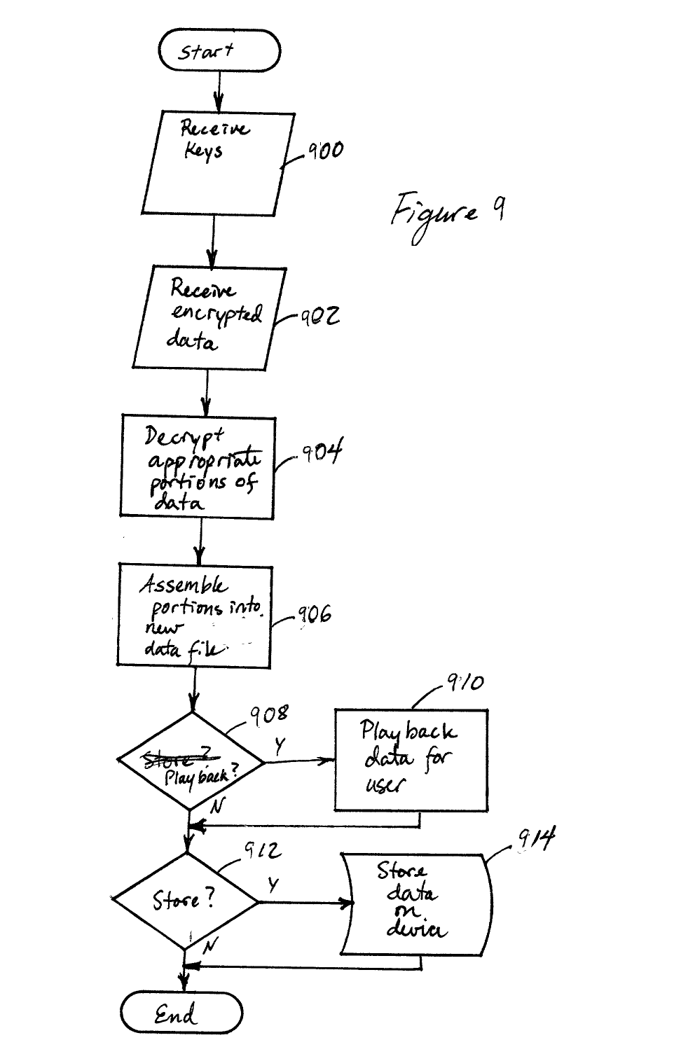

FIG. 9 is a flowchart representation of a process of receiving and decrypting a data file in accordance with a preferred embodiment of the present invention. First, the client device (recipient) receives one or more keys corresponding to the data to be transmitted (step 900). The client then receives encrypted data (step 902). Next, the portions of the data that correspond to the received keys are decrypted (step 904). Those decrypted portions are assembled into a new file having a new quality level (step 906). If the file is to be played back (and if this is even possible given the nature of the data) (step 908:Yes), then the data is played back (reproduced) for the user (step 910). If the file is to be stored (step 912:Yes), then the data is stored by a storage device (e.g., tape drive, compact disc writer, disk drive, etc.).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as disk (e.g. disk or disc), tape, solid state, probe, volumetric (e.g. holographic), and transmission-type media, such as digital and/or analog communications links, wired and/or wireless communications links using transmission forms, such as, for example, radio frequency, infrared, and light wave transmissions. The computer readable media may take the form of coded formats that are decoded for actual use, execution, or consumption in a particular data processing or data presentation system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of transmitting data in a network comprising:
generating a plurality of keys;
dividing the data into portions;
encrypting each of the portions with one of the plurality of keys in a one-to-one relationship; and
transmitting the encrypted portions through the network.

2. The method of claim 1, further comprising:
transmitting at least one of the plurality of keys through the network.

3. The method of claim 2, wherein the at least one of the plurality of keys is transmitted over an encrypted communications channel.

4. The method of claim 3, wherein the encrypted communications channel is a Secure Sockets Layer (SSL) channel.

5. The method of claim 1, wherein the data includes at least one of audio data, video data, and digital data.

6. The method of claim 1, wherein the encrypted portions are transmitted to a computer.

7. The method of claim 1, wherein the encrypted portions are transmitted to a network-attached storage device.

8. The method of claim 7, wherein the storage device stores the data in a removable medium.

9. The method of claim 8, wherein the removable medium is one of a compact disc (CD) and a digital versatile disc (DVD).

10. The method of claim 8, wherein the removable medium is one of a tape cartridge and a tape cassette.

11. The method of claim 8, wherein the removable medium is one of a holographic disc and a holographic cube.

12. The method of claim 7, wherein the storage device is one of a tape drive and a disk drive.

13. The method of claim 7, wherein the storage device is a solid-state storage device.

14. A method, operative in a client, of downloading data from a server, comprising:
receiving encrypted data from the server, wherein different portions of the encrypted data are encrypted using different keys;
receiving at least one key corresponding to the encrypted data;
receiving a quality level corresponding to the at least one key;
using the at least one key to decrypt such portions of the encrypted data as can be decrypted using the at least one key; and
assembling the decrypted portions to form decrypted data that conforms to the quality level.

15. The method of claim 14, wherein the quality level is one of a sampling rate, resolution, and compression quality.

16. The method of claim 14, further comprising playing back the decrypted data.

17. The method of claim 14, wherein the decrypted data includes at least one of audio data, video data and digital data.

18. The method of claim 14, further comprising storing the decrypted data in a storage device.

19. The method of claim 18, wherein the storage device stores the decrypted data in a removable medium.

20. The method of claim 19, wherein the removable medium is one of a compact disc (CD) and a digital versatile disc (DVD).

21. The method of claim 19, wherein the removable medium is one of a tape cartridge and a tape cassette.

22. The method of claim 19, wherein the removable medium is one of a holographic disc and a holographic cube.

23. The method of claim 18, wherein the storage device is one of a tape drive and a disk drive.

24. The method of claim 14, wherein the at least one key is received from the server.

25. The method of claim 14, wherein the at least one key is received through an encrypted transmission.

26. A computer program product in a computer-readable medium for transmitting data in a network comprising instructions for:
generating a plurality of keys;
dividing the data into portions;
encrypting each of the portions with one of the plurality of keys in a one-to-one relationship; and
transmitting the encrypted portions through the network.

27. The computer program product of claim 26, comprising additional instructions for:
transmitting at least one of the plurality of keys through the network.

28. The computer program product of claim 27, wherein the at least one of the plurality of keys is transmitted over an encrypted communications channel.

29. The computer program product of claim 28, wherein the encrypted communications channel is a Secure Sockets Layer (SSL) channel.

30. The computer program product of claim 26, wherein the data includes at least one of audio data, video data, and digital data.

31. The computer program product of claim 26, wherein the encrypted portions are transmitted to a computer.

32. The computer program product of claim 26, wherein the encrypted portions are transmitted to a network-attached storage device.

33. The computer program product of claim 32, wherein the storage device stores the data in a removable medium.

34. The computer program product of claim 33, wherein the removable medium is one of a compact disc (CD) and a digital versatile disc (DVD).

35. The computer program product of claim 33, wherein the removable medium is one of a tape cartridge and a tape cassette.

36. The computer program product of claim 33, wherein the removable medium is one of a holographic disc and a holographic cube.

37. The computer program product of claim 32, wherein the storage device is one of a tape drive and a disk drive.

38. The computer program product of claim 32, wherein the storage device is a solid-state storage device.

39. A computer program product in a computer-readable medium for downloading data from a server, comprising instructions for:
receiving encrypted data from the server, wherein different portions of the encrypted data are encrypted using different keys;
receiving at least one key corresponding to the encrypted data;
receiving a quality level corresponding to the at least one key;
using the at least one key to decrypt such portions of the encrypted data as can be decrypted using the at least one key; and
assembling the decrypted portions to form decrypted data that conforms to the quality level.

40. The computer program product of claim 39, wherein the quality level is one of a sampling rate, resolution, and compression quality.

41. The computer program product of claim 39, comprising additional instructions for playing back the decrypted data.

42. The computer program product of claim 39, wherein the decrypted data includes at least one of audio data, video data and digital data.

43. The computer program product of claim 39, comprising additional instructions for storing the decrypted data in a storage device.

44. The computer program product of claim 43, wherein the storage device stores the data in a removable medium.

45. The computer program product of claim 44, wherein the removable medium is one of a compact disc (CD) and a digital versatile disc (DVD).

46. The computer program product of claim 44, wherein the removable medium is one of a tape cartridge and a tape cassette.

47. The computer program product of claim 44, wherein the removable medium is one of a holographic disc and a holographic cube.

48. The computer program product of claim 43, wherein the storage device is one of a tape drive and a disk drive.

49. The computer program product of claim 39, wherein the at least one key is received from the server.

50. The computer program product of claim 39, wherein the at least one key is received through an encrypted transmission.

51. A data processing system for transmitting data through a network, comprising:
a bus system;
a processing unit, including at least one processor and connected to the bus system;
memory connected to the bus system; and
a set of instructions in the memory, wherein the processing unit executes the set of instructions to perform the acts of:
generating a plurality of keys;
dividing the data into portions;
encrypting each of the portions with one of the plurality of keys in a one-to-one relationship; and
transmitting the encrypted portions through the network.

52. The data processing system of claim 51, wherein the encrypted portions are transmitted to a computer.

53. The data processing system of claim 51, wherein the encrypted portions are transmitted to a network-attached storage device.

54. A data processing system for downloading data from a server, comprising:
a bus system;
a processing unit, including at least one processor and connected to the bus system;
memory connected to the bus system; and
a set of instructions in the memory, wherein the processing unit executes the set of instructions to perform the acts of:
receiving encrypted data from the server, wherein different portions of the encrypted data are encrypted using different keys;
receiving at least one key corresponding to the encrypted data;
receiving a quality level corresponding to the at least one key;
using the at least one key to decrypt such portions of the encrypted data as can be decrypted using the at least one key; and
assembling the decrypted portions to form decrypted data that conforms to the quality level.

55. The data processing system of claim 54, wherein the quality level is one of a sampling rate, resolution, and compression quality.

56. The data processing system of claim 54, wherein the processing unit executes the set of instructions to perform the additional act of playing back the decrypted data.

57. The data processing system of claim 54, wherein the decrypted data includes at least one of audio data, video data and digital data.

58. The data processing system of claim 54, wherein the processing unit executes the set of instructions to perform the additional act of storing the decrypted data in a storage device.
